(19) United States
(12) Patent Application Publication
(10) Pub. No.: US 2003/0002708 A1
(43) Pub. Date: Jan. 2, 2003

(54) System and method for watermark detection

(76) Inventor: Joe Pasqua, Menlo Park, CA (US)

Correspondence Address: Tyler S. Brown, Morrison & Foerster LLP, 2000 Pennsylvania Ave., N.W., Washington, DC, 20006-1888, US

(21) Appl. No.: 10/080,569

(22) Filed: Feb. 25, 2002

Related U.S. Application Data
(60) Provisional application No. 60/270,594, filed on Feb. 23, 2001.

(51) Int. Cl. G06K 9/00

(52) U.S. Cl. 382/100

(57) ABSTRACT

A system and method is provided for increasing watermark detection speed and accuracy by using detection information during the detection process. When a source document is watermarked, detection information is determined and stored for later use in the detection process. The detection information can be in any format and includes information about the features of the source document wherein the watermark information is embedded. During detection of watermark values in a non-source document, the watermark detector uses the detection information to determine which of the non-source document features contain the watermark information.

### FIELD OF THE INVENTION

The present invention relates to a system and method for watermark detection in a dissimilar target media. More particularly, the present invention relates to using source media analysis to aid watermark detection in a dissimilar target media.

### BACKGROUND OF THE INVENTION

When watermarking the electronic form of a textual document it is often desirable to be able to detect the watermark from either the electronic form or from a hardcopy. The hardcopy pages are scanned into the computer resulting in an image of each page. In this form a great deal of semantic information has been lost. For example, there is no notion of a word or a paragraph—there are just pixels.

This is a problem for many document watermarking algorithms because they use changes to things like line spacing or margins to carry the watermark information. Thus, to detect the watermark, these features must be found.

Because of the loss of semantic information, a great deal of processing must be performed to infer the features of the original document. For instance, one must use analytic techniques to determine which pieces of the page are text, which are line art, and which are images. This is necessary to correctly locate and synchronize to the embedded watermark.

Watermarking techniques usually embed and detect watermarks in semantically equivalent representations of the content. For example, an image watermarking scheme embeds and detects watermarks in images. In the area of watermarking textual documents, other techniques for detecting watermarks from hard copy deal only with operating in the image space. For example, see U.S. Pat. Nos. 6,086,706 and 5,629,770.

Some watermarking systems perform an analysis of the piece of source content and store information that will be used later to speed the application of watermarks in that same piece of content later. The idea is that if a given piece of content is to be watermarked a number of times with different watermark values, the content can be preprocessed when it is first encountered to derive information that will make the subsequent application of watermarks faster. In these systems, the analysis and the information derived from the analysis both apply to the same form of content. In addition, these systems use the information only at embedding time.

These sorts of image analysis can be slow, produce inexact results, and in some cases are guaranteed to produce an incorrect result. A need exists for a way to detect watermarks in the scanned image of the hardcopy of a textual document without having to perform costly, and potentially incorrect, image analysis.

### SUMMARY OF THE INVENTION

The present invention provides a system and method for overcoming the disadvantages and drawbacks of conventional systems. This invention provides a system and method for using source media analysis to aid in watermark detection in a dissimilar target media.

In accordance with one embodiment of the present invention, a method of watermark detection is provided. The method of watermark detection includes analyzing a source document, embedding the watermark information in the source document, determining detection information, analyzing a nonsource document, and using the detection information to determine the watermark value for the nonsource document.

In accordance with one embodiment of the invention, a system for watermark detection using analysis information of the source document in the detection is provided. The system includes a first computer system that embeds watermark information in a source document and determines detection information for the source document, and a detection system including a watermark detector that detects a watermark value for a nonsource document using the detection information generated by the first computer system.

Still other embodiments of the present invention will become apparent to those skilled in the art from the following detail description, wherein is shown and described only the embodiments of the invention by way of illustration of the best moods contemplated for carrying out the invention. As will be realized, the invention was capable of modification in various obvious aspects, all without departing from the spirit and scope of the present invention. Accordingly, the drawings and details description ought to be regarded as illustrative in nature and not restrictive.

### BRIEF DESCRIPTION OF THE DRAWINGS

FIG. 1 depicts an example of the source document.

FIG. 2 depicts one embodiment of the processing steps and data flow.

FIG. 3 depicts an example page.

FIG. 4 depicts an example of the process according to one embodiment of the invention.

FIG. 5 depicts a block diagram of a system according to one embodiment of the invention.

### DETAILED DESCRIPTION OF THE INVENTION

This invention provides a faster, more accurate way to detect watermarks in the hardcopy version of a document. The invention uses information present in the semantically rich representation of a source document to facilitate the efficient and accurate detection of a watermark in a semantically poor representation of the document. This situation arises since it is desirable to be able to watermark the electronic form of a document and detect the watermark in a hardcopy version. The hardcopy is scanned into the computer and represented as an image. The image is semantically poor since it contains none of the higher level information present in the original such as the words, lines, paragraphs, etc.

The present invention analyzes a semantically rich source document 10 to determine information about the features 12 that will carry the watermark information 14. The semantically rich source document 10 can be in any form such as Adobe PDF or Microsoft Word. The set of documents features 12 in the source document 10 are features that may be used to carry the watermark information 14. The features 12 could be lines, words, paragraphs, margins, or any number of features.

The detection information 16 gathered by the analysis of the source document 10 is preferably stored in the form that can be interpreted by a watermark detector 18. The watermark detector 18 operates on a semantically poor representation of the document 20. The semantically poor version 20 of the watermark document can be in any format such as image formats TIFF, GIF, or JPEG. The detection information 16 is used by the watermark detector 18 to locate in document 20 the features 12 that were used to carry the watermark information 14.

The present intervention provides many benefits including increased detection speed and detection accuracy. For example, without detection information 16, the watermark detector 18 would have to use image analysis operations to find the relevant features 12. Such an approach would involve segmenting the import document 20 into general features 22 of various types and determining a correspondence between these general features 22 and the watermark features 12 used to carry the watermark. The general features 22 can be such things as characters, words, lines, line art or images. By referring to an image analysis operation to find the relevant features, the detection process is significantly slowed. Thus, having a description of the watermark features 12 that is derived from the source document 10 obviates the need for this sort of costly image processing.

The following example illustrates the distinctions between the detection information 16 and the watermark information 14. The watermark information 14 could be the name of the recipient of the source document 10. This watermark might be encoded into the document by shifting the position of lines or words within lines to encode bits of the name. To extract the watermark information 14, the detector must be able to find the lines or words into which the watermark has been encoded. The detection information 16 tells the detector where to find these lines on the page. For example, one bit of the watermark information 14 might be encoded as a shift in the margin of a line of text in the source document 10. The line of text is a document feature 12. Identifying a line of text in the source document 10 is easy to do since the source document, e.g. a Microsoft Word file, carries this information directly. Identifying the line of text in a scanned image of the document can be difficult and inaccurate since the image must be analyzed and the line structure inferred by the detector. To avoid this difficulty, the present invention collects the location of the line on the page from the source document 10 and stores it as part of the detection information 16.

Another example involves watermarking a graphic composed of lines and arcs. The watermarking algorithm embeds the watermark information 14 into the rich source document 10 where lines and arcs are clearly identified and their positions are known precisely. The watermarking algorithm modifies the lines and arcs (document features 12) to carry the watermark information 14. When the watermark information is to be extracted from an image representation of the document, the detector would have to analyze the image to find the lines and arcs that carry the watermark information. Once again, this is error prone and slow. To avoid this, the watermark embedding program collects detection information 16 that is readily available in the source document 10 about the location of the lines and arcs (document features 12) that carry the watermark information 14. At watermark detection time, the detector uses the detection information 16 to locate the relevant lines and arcs rather than doing a slow and inexact image analysis.

The invention increases detection accuracy since the objects used to carry the watermark need not be inferred from an analysis of the page image. Such an analysis can be flawed due to noise in the semantically poor document 20 and other factors. After all, an image analyzer is ultimately just making an educated guess about which pixels correspond to which high level features. In some cases it is impossible to accurately determine the features 12 as they are known in the source document 10. In, for example, a watermarking scheme that varies the position of lines of text in a document to carry watermark information, the detector must determine which pixels in the semantically poor document 20 correspond to lines of text in the source document 10.

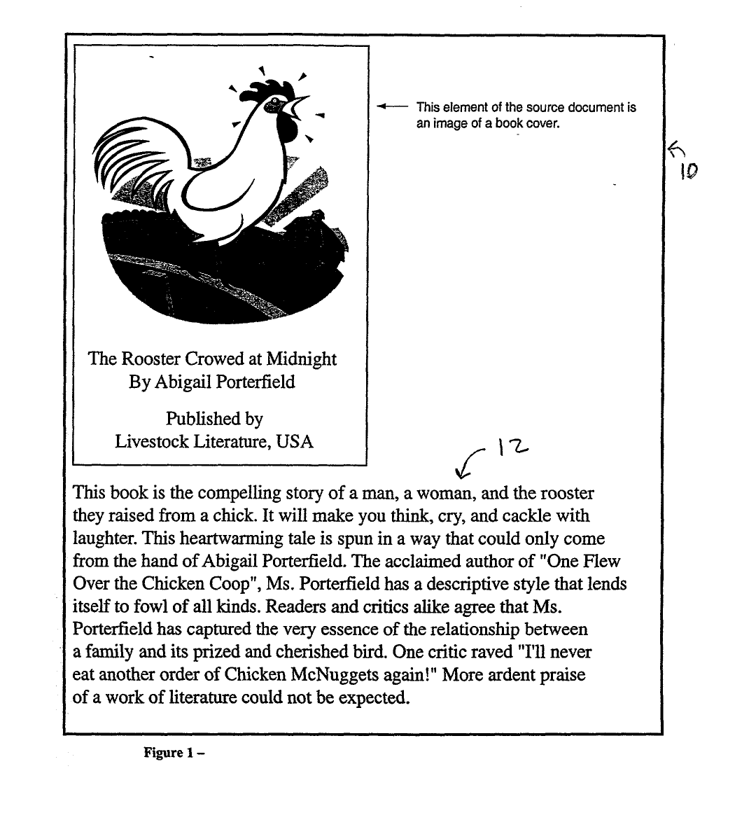

Consider an original document that contains an image of a tree and ten lines of text. A good image analysis module might accurately segment the page into an image object and ten lines of text. The detector could then analyze the locations of the lines of text to extract the watermark. Now consider a page that contains the same ten lines of text, but replaces the image of the tree with a picture of a book cover (see FIG. 1). From the perspective of the watermark embedding software, the picture of the book cover is just an image, and therefore contains no lines of text that will contribute to carrying the watermark data.

From the perspective of a detector operating on the semantically poor document 20, there is no way to distinguish between a line of text that is part of the picture of the book cover and one of the ten actual lines of text. The detector will not be able to accurately extract the watermark since it cannot determine which features of the semantically poor document 20 correspond to the features of source document 10. This is a single example of the detector being confused by lack of semantic information in the semantically poor document 10.

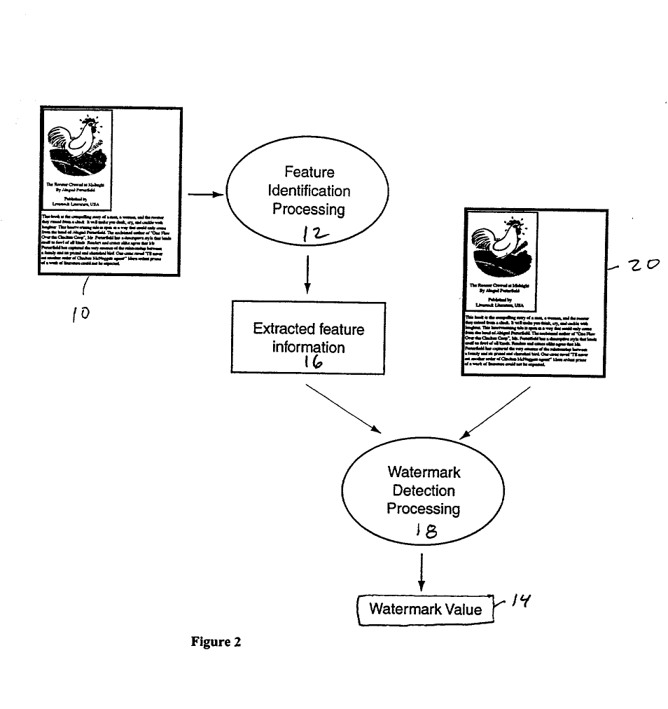

In this invention, the system and method preferably identify the features 12 that are used to carry watermark information 14 in the source document 10 and where they are located on the page. We store this detection information 16 so that it can later be used by the detector 18 (see FIG. 2). Given detection information 16, the detector does not have to guess at the features based on image analysis. It can make use of the correct information that was derived from source document 10.

The precise format of detection information 16 and the data it carries can be tailored to the watermarking algorithm being employed. That is, not all of the semantic information of source document 10 needs to be carried in detection information 16. Only information relevant to the watermarking algorithm needs to be preserved. Detection information 16 can be expressed in any format desired. The examples in this description use a particular schema of the Extensible Markup Language (XML) to carry the information.

The following example demonstrates a use of this invention with a particular watermarking algorithm. This is merely meant as an illustration and is not the only way that this invention can be used. A person skilled in the art can see that a major utility of this invention is that it can be applied to many different watermarking algorithms operating in the domain of electronic documents whose watermarks must be detected from printed versions.

Consider a textual watermarking scheme that relies on the spacing between words to carry watermark data. Such an approach is described in U.S. Pat. Nos. 6,086,706 and 5,629,770, incorporated herein by reference. This scheme changes the spacing between specific groups of words and it is those changes that carry the watermark data. In order to detect the watermark in the semantically poor document 20, the words that carry the watermark data must be located.

If the detector 18 relies on image analysis to find the words on a page, it could easily be fooled by words that were not present as text in source document 10 (refer to the discussion above and see FIG. 1).

Instead, the present invention could identify the words of source document 10 used to carry the watermark and store their locations in detection information 16. Later, the detector 18 would use detection information 16 to locate the words in the semantically poor document 20. The following XML structure is an example of how detection information 16 might be represented in this case.

```
<Document name=“The Rooster Crowed at Midnight”>
  <Page number=“1”>
    <Block numberOfLinesInBlock=“33”>
      <BoundingBox x=“0” y=“0” w=“2400” h=“1700”/>
      <LineOfWords=number=“1” numberOfWords=“13”>
        3, 7, 10
      </LineOfWords>
      <LineOfWords number=“3” numberOfWords=“17”>
        2, 9, 12, 15
      </LineOfWords>
      . . .
    </Block>
    <Block numberOfLines=“27”>
      . . .
    </Block>
  </Page>
  <Page number=“122”>
    . . .
  </Page>
</Document>
```

This structure contains an element that corresponds to each page of the document that carries watermark information. Each page is segmented into non-overlapping blocks of text. Each block specifies its bounding box (i.e. location and size) as well as the number of lines of text that are present in the original. This number may be used as part of the detection algorithm or just for consistency checking. Each block element contains some number of LineOfWords elements. Each of these represents a line of text and identifies the number of the line in the block, the number of words in the line, and the index of each word that can carry watermark information.

In the example above, the first page contains two blocks. The first block contains several LineOfWords items. The first of those identifies words 3, 7, and 10 as those that can be shifted in order carry the watermark information.

This structure would not have any block that corresponds to an image since images contain no accessible words. Thus the image of the book cover in FIG. 1 would be omitted from this structure thereby avoiding confusion over which words should be included in the watermark detection process.

In another example, a watermark is embedded in a source document 10 that is a graphic composed of lines and arcs. The watermark information 14 is embedded by making subtle modifications to a subset of the lines and arcs in the graphic. These are the document features 12. During the embedding process the location and shape of each document feature used to carry a part of the watermark is collected and stored as detection information 16. The following XML structure is an example of how the detection information 16 might be represented in XML form.

```
<Graphic name=“My Company Logo”>
  <Shape type=“Line”>
    <StartPoint x=“58.93” y=“4.88”>
    <EndPoint x=“103.2” y=“63.03”>
  </Shape>
  <Shape type=“Arc”>
    <Center x=“0” y=“0”>
    <Radius>1</Radius>
    <AngleRange start=“0” end=“45”>
  </Shape>
  . . .
</Graphic>
```

This structure contains a Shape element corresponding to each document feature used to carry watermark information. Each Shape identifies itself as either a line or an arc and provides the relevant geometric information needed to describe it. The set of feature included in detection information 16 is normally a small subset of the total number of features in the document. Not all of the information from the source document 10 needs to be repeated in the detection information 16. For example, the color associated with a given line or arc is not relevant here while it must be contained in the source document 10.

The detection information 16 is a subset of the information in the source document 10. It contains only data regarding features that either carry watermark information 14 or are used in aiding in the detection of that information. There need not be information about every document feature in the source. Furthermore, even for the document features that carry watermark information, not all of the information in the source document describing that feature needs to be included in the detection information 16. For example, when embedding a watermark in textual information by modifying intra-line or intra-word spacing, information about type faces need not be carried. Only information about the locations of lines is relevant. By dropping information that is not needed by the detection process, the detection information 16 is made quite small relative to the source document 10.

During the detection process, the detection information 16 is used to locate the document features that carry the watermark. In the Graphic example above, the detector would know that a line exists whose starting point is the coordinate (58.93, 4.88) and whose ending coordinate is (103.2, 63.03). The detector can use this information to find the line in the scanned image rather than having to perform complex algorithms such as a Hough Transform to locate the line. The same is true for arcs. The process makes available information about the document features that is easy to extract from the source document, but difficult to determine from the semantically poor document.

The overall flow of this process is as follows:

1. Receive a source document 10 that is to be watermarked.

2. Analyze source document 10 to determine the document features 12 that will be used to carry the watermark information. This analysis and the result resultant features 12 are dependent on the watermarking algorithm in use.

3. Store detection information 16 about the nature and location of the features in a file.

4. During detection, read detection information 16 to determine features 12. Identify these features in semantically poor document 20 using the segmentation and location information provided in detection information 16.

5. Having identified and located the features of interest in semantically poor document 20, use the watermark detection algorithm to read the watermark value.

Source document 10 could be analyzed each time the detector 18 is run rather than just once as indicated above. Thus, if it is known in advance that the source document will be available at detection time, the creation of the detection information may be deferred until detection time. This might be a reasonable approach if:

detection information 16 is not used in the embedding process;

source document 10 will be present at detection time; and

it is undesirable to have to store and maintain detection information 16.

Other schemes for watermarking textual documents rely on the locations of lines of text to embed a watermark. Examples of this approach can be found in U.S. Pat. Nos. 6,086,706 and 5,629,770. As in the example of word-shifting given above, line-shifting approaches also require the accurate detection of source features at detection time. In this case the features 12 of interest are lines of text and the analysis detection information 16 describes blocks of text and the lines in those blocks that are used to carry watermark and other information. For example, detection information 16 might indicate which lines have been deliberately left untouched to serve as reference points allowing the detector to better register the original document 10 to poor document 20.

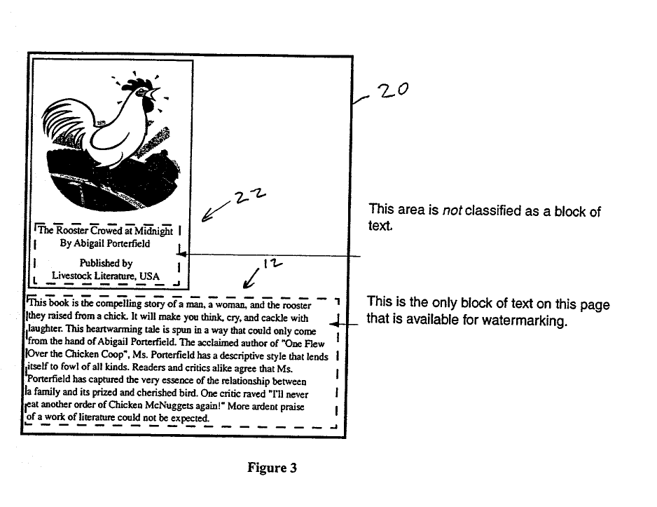

The source analysis phase would be a matter of decomposing the page into non-overlapping blocks of text content that excluded any areas containing non-text content. FIG. 3 shows how the sample page shown in FIG. 1 would be decomposed into blocks. Note that the text within the image of the book cover is not included in any block since it contains no text from the perspective of the source document 10. A key benefit of this invention is that analysis in the source space is much simpler and more accurate than in the image space.

This method is applicable to a variety of techniques for watermarking documents. This allows a watermark algorithm provider to change or improve his offerings without having to find new image analysis methods that apply to the new offerings.

A subsidiary benefit of this invention is that this same information may speed the application of transactional watermarks by providing the embedding program with information about which objects can carry watermark information, thus avoiding repeated analysis of source document 10.

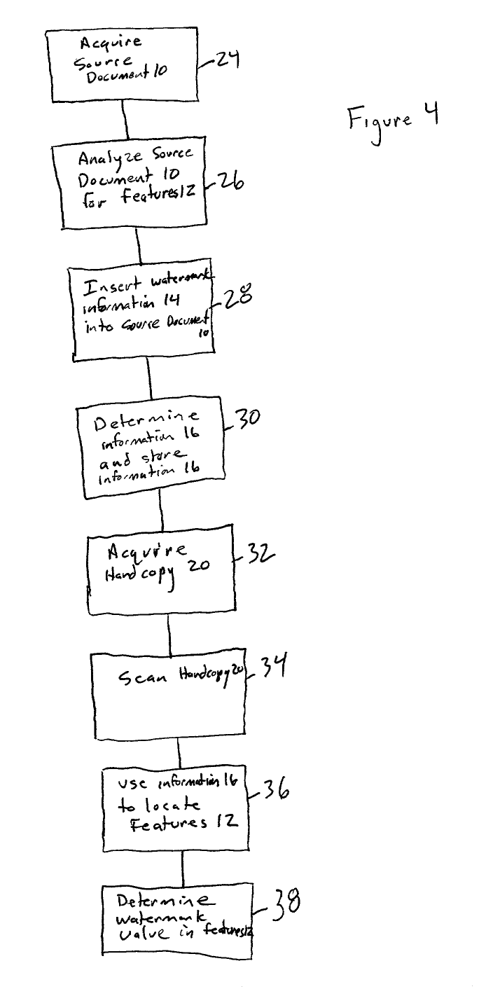

FIG. 4 shows one embodiment of the process according to this invention. Step 24, acquire source document 10. Step 26, analyze source document 10 for features 12.

Step 28, insert watermark information 14 into source document 10. Step 30, determine detection information 16 and store detection information 16.

Step 32, acquire hard copy 20. Step 34, scan hard copy 20. Step 36, use detection information 16 to locate features 12 and hard copy 20. Step 38, determine watermark value in features 12.

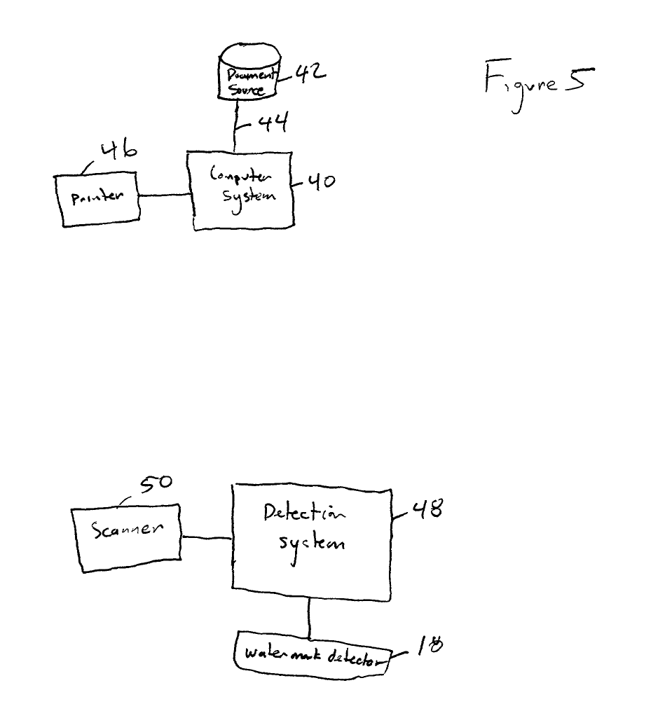

FIG. 5 shows one example of the system according to the present invention. Computer system 40 is connected to a document source 42 and connection 44. Computer system 40 can be a type of system that is able to acquire, analyze, and insert watermark information into a document. Document source 42 can be any number of components containing a source document 10 such as a database connected to system 40 locally or a remote database connected to the system through a network connection. In addition, document source 42 could be a scanner that scans a hard copy of an original creating a semantically rich source document using, for example, an OCR process. Computer system 40 acquires the source document 10 from document source 42. As described, for example, in FIG. 4, system 40 analyzes the source document 10 to determine the features 12 and insert watermarking information 14 into features 12. Computer system 40 also determines detection information 16 and stores detection information 16 for use in the detection process. Detection information 16 can be in any format and includes information allowing the detection of the relevant features to be analyzed for determination of the watermark value in those features. Computer system 40 is also connected to a distribution or publication component such as printer 46.

Once the distribution or publication component generates a hard copy, the hard copy is distributed through normal channels. When a hard copy is acquired and the watermark for that hard copy needs to be determined, detection system 48 can be employed. The detection system 48 can be the same as computer system 40 or an entirely different detection system. In this example, the hard copy is analyzed by scanner 50 and is connected to the detection system 48. Detection system 48 requires and uses detection information 16 to determine the relevant features 12 that contain a watermark information 14. A watermark detector 18 will then be employed on the scanned hard copy to determine the watermark value of the relevant features 12. The watermarked source document need not be printed at system 40, it could be distributed electronically and printed elsewhere.

Although the invention has been described relative to a particular embodiment, one of skill in the art will appreciate that this description is merely exemplary and the system and method of this invention may include additional or different components, while operating within the scope of the invention.

What is claimed is:

1. A method of watermarking a document comprising:
acquire a source document;
analyzing the source document for features;
inserting watermark information into the features of the source document;
determining detection information;
storing the detection information;
acquiring a nonsource document;
scanning the nonsource document;
locating the features in the nonsource document using the detection information; and
determining a watermark value of the nonsource document.

2. The method of watermarking a document according to claim 1, wherein the detection information includes information of the location of the features.

3. The method of watermarking a document according to claim 2, wherein the source document is a semantically rich document and the nonsource document is a semantically poor document.

4. The method of watermarking a document according to claim 3, wherein the non-source document is a hardcopy of the source document.

5. A method of watermark detection, comprising:
analyzing a semantically rich document;
determining detection information based on the analysis of the semantically rich document, the detection information including information on the watermark features and location of the watermark features;
scanning a semantically poor document; and
determining a watermark value of the semantically poor document using the detection information.

6. The method of watermark detection according to claim 5, wherein the semantically rich document is an electronic document and the semantically poor document is a hardcopy.

7. A method of watermark detection, comprising:
analyzing a nonsource document; and
detecting a watermark value of the nonsource document using detection information.

8. The method of watermark detection according to claim 7, wherein the detection information includes information on the location of source features.

9. The method of watermark detection according to claim 8, wherein the nonsource document is a hardcopy of a source document.

10. A system for watermark detection, comprising:
a first system connected to a document source;
a publication component connected to the first system;
a second system connected to a scanning device; and
a watermark detector connected to the second system.
